(19) United States
(12) Patent Application Publication
(10) Pub. No.: US 2013/0089700 A1
(43) Pub. Date: Apr. 11, 2013

(54) COMPOSITE BOARDS MADE WITH SORGHUM STALKS AND A THERMOPLASTIC BINDER AND PROCESSES FOR MAKING SAME

(71) Applicants: Michael Warren Hurst, San Diego, CA (US); Chusheng Qi, Shaanxi (CN); Michael Wolcott, Pullman, WA (US); Vikram Yadama, Pullman, WA (US)

(72) Inventors: Michael Warren Hurst, San Diego, CA (US); Chusheng Qi, Shaanxi (CN); Michael Wolcott, Pullman, WA (US); Vikram Yadama, Pullman, WA (US)

(21) Appl. No.: 13/644,826

(22) Filed: Oct. 4, 2012

Related U.S. Application Data
(60) Provisional application No. 61/544,884, filed on Oct. 7, 2011.

(51) Int. Cl. C08K 11/00; B32B 5/12

(52) U.S. Cl. CPC C08K 11/00; B32B 5/12
USPC 428/112; 264/330; 428/298.1; 428/136; 524/9

(57) ABSTRACT

A composite board having a sorghum stalk material component and a thermoplastic binder component is disclosed together with a corresponding method of manufacture. To prepare the composite board, the sorghum stalk material is harvested, dried and refined into fibers, particles or slit-stalks. In some cases, the stalk material is first combined with a thermosetting binder such PMDI. Next, the stalk material is arranged into one or more layers and then combined with a thermoplastic binder, such as HDPE film, in a stack. In some instances, recycled HDPE may be used. The stack is thermocompressed in a press at a preselected temperature to compress the sorghum and thermoplastic binder to a preselected board thickness. The board is then cooled to below the softening temperature of the thermoplastic resin. After cooling, the board can be cut or trimmed to its final desired dimensions.

This application claims priority to provisional U.S. patent application No. 61/544,884 filed Oct. 7, 2011 titled “Composite Boards made with Sorghum Stalks and a Thermoplastic Binder and Processes for Making Same.” This application is related to provisional U.S. patent application No. 61/544,856 filed Oct. 7, 2011 titled “Oriented Strand Boards made with Sorghum Stalks and Processes for Making Same.” The entire contents of provisional application 61/544,884 and provisional application 61/544,856 are hereby incorporated by reference herein.

### FIELD OF THE INVENTION

The present invention pertains generally to press-board products. More particularly, the present invention pertains to press-board products made from materials having a relatively low adverse environmental impact. The present invention is particularly, but not exclusively, useful as a press-board product made from sorghum stalk material and a thermoplastic binder.

### BACKGROUND OF THE INVENTION

Agrifiber board based on sorghum straw (i.e. sorghum stalks) offers an environmentally responsible product useful as a direct substitute for particleboard, medium-density fiberboard (MDF), plywood and/or wood-based oriented strandboard (OSB). In performance, environmental impact, and cost, it is comparable to or better than those wood-based products, and unlike many of them, emits neither formaldehyde nor volatile organic compounds (VOCs). The nature of the sorghum stalk makes it a better fiber for construction than many other agrifiber materials.

Sorghum is a genus of numerous species of coarse, upright growing grasses having stalks ranging in the length from about 5-15 feet long. Sorghum can be grown under a wide range of soil and climatic conditions including arid areas where crops such as corn would require substantial irrigation. The primary cultivated species, sorghum bicolor, grows well in hot, arid climates, making it popular with subsistence farmers.

In addition to the classification of Sorghum into species, the sorghum species and hybrids are often classified in sorghum types. Types include grain sorghum, forage sorghum, Sudangrass which is a subspecies of sorghum bicolor and Sorghum-sudangrass hybrids (which are a cross between the two forage type sorghums) and Sorghum-almum. Forage Sorghums includes sorgo, sweet sorghum, dual purpose (grain and forage) varieties, and hybrids. Sweet sorghum and forage sorghum hybrids are often used for ethanol production and are sometimes referred to as energy sorghums. As provided further below, the stalks of so-called energy sorghums may be particularly suitable for use in making composite boards due to their superior strength and properties.

Sorghum is used for both grain and fodder production and has been identified as a possible source of ethanol as it provides high biomass yield with much lower irrigation and fertilizer requirements than corn. Grain sorghum is grown in the United States, Mexico, India, and throughout Africa and South Asia. It is considered the fifth most important cereal crop in the world. Notably, sorghum straw is a rapidly renewable resource as it can grow more than 2 m (6 ft) tall in a single season. Similar wood growth can take many years. Sorghum stalks are far thicker and more substantial than wheat or rice straw, allowing for better engineering of the product. The center of a sorghum stalk is far less dense than the hard outer ring, so the material can be compressed to different degrees. The sorghum crop is frequently grown using less fertilizers and pesticides than other grains, resulting in plant material that is low in chemical residues. As an added benefit, it is naturally resistant to many types of fungi and insects.

Sorghum stalks and sorghum stalk bagasse (the stalk material remaining after juice extraction for ethanol production) are currently used for thatch, fences, baskets, brushes, paper and cattle fodder. However, the supply of Sorghum stalks and sorghum stalk bagasse greatly exceeds demand, and as a consequence, a large amount of this material is either plowed under or burned. Specifically, in many parts of the world, the straw is burned in the field. After harvest time, the burning can be so plentiful that the skies darken with soot. Traveling miles across the landscape, the resulting smoke plumes are so thick they can be seen in photos taken from outer space. This burning not only pollutes the air, but emits greenhouse gases (GHGs) linked to the current climate crisis.

Utilizing agricultural waste diverts it from this process, eliminating a source of GHGs and large-particle air pollution. Another green aspect of using the waste stalks such as Sorghum as a raw material is that the embedded energy to produce agrifiber panels is less than with wood panels. In making both composite wood and agrifiber boards, moisture inside cells or between them must be removed for proper penetration of binder. Agrifibers generally have larger cellulose cells than wood, so the cell wall is softer and thinner, and moisture removal requires less energy.

The cellulose of agrifiber cell walls such as Sorghum is more easily penetrated by chemicals than similar structures in wood fiber, making modifications to improve material properties more effective. For example, agents such as acetyls (commonly used in engineered wood panels to improve dimensional stability, moisture resistance, and strength) are more effective when treating agrifiber stalks such as Sorghum. Ease of cell penetration in agrifiber such as Sorghum stalk material also makes it more likely than wood to accept new green binders such as soybean protein, modified flour pastes, recycled thermoplastic binders.

Traditional wood-based press-board products include particle board, fiberboard and oriented strand board (OSB). Traditional wood-based OSB also known as waferboard, Sterling board, Exterior board and SmartPly is a structural wood composite formed by layering strands (flakes) of wood in specific orientations. Traditional wood-based OSB is typically made of wood strands, also called flakes, sliced in the long direction from small diameter, fast growing round wood logs, such as freshly harvested aspen poplar, southern yellow pine or other mixed hardwood and softwood logs, and bonded with an exterior-type binder under heat and pressure.

Traditional wood-based OSB is typically manufactured by layering wood strands ranging in length from about 3½″ to 6″ and approximately 1″ wide. The strands are coated with wax and resin binders (95% wood, 5% wax and resin) and then compressed and bonded together in a thermal press. Layers are created by shredding the wood into strips, which are sifted and then oriented, for example, using belts or wire cauls. Generally, the layers are built up with the external layers aligned in the panel's strength axis with internal layers cross-oriented. The finished product has similar properties to plywood, but is cheaper and more uniform.

Traditional wood-based OSB is currently used as a structural panel for a wide range of construction and industrial applications. The most common uses of traditional OSB are as sheathing in walls, floors, and roofs. Panels are available in nominal 4×8′ sheets (1220×2440 mm) or larger, and thicknesses of ¼″, ⅜″, 7/16″, 15/32″, 19/32″, 23/32″, ⅞″, 1⅛″ and 1¼″. OSB is also used extensively for the webs of prefabricated wood Hoists and in structural insulated panels (SIPS), also known as foam-core sandwich panels. Property specifications for a typical traditional wood-based OSB (CSA 0437; Grade O-2) include minimum modulus of rupture, parallel (29.0 MPa) perpendicular (12.4 MPa); minimum modulus of elasticity, parallel (5500 MPa), perpendicular (1500 MPa); minimum internal bond (0.345 MPa); maximum linear expansion, oven dry to saturated, 0.35% parallel, 0.50% perpendicular; maximum thickness swell, 15% for ½″ thick or less, 10% for greater than ½″; and Minimum lateral nail resistance of 70 t N, where t=thickness in millimeters.

Traditional wood-based particle board is a composite product manufactured from wood particles, such as wood chips, sawmill shavings, or even saw dust, and a binder which is pressed and extruded. Traditional wood-based particleboard is generally cheaper, denser and more uniform than conventional wood such as plywood and is substituted for wood when appearance and strength are less important than cost. Generally, traditional wood-based particleboard is painted or covered with wood veneers that are glued onto surfaces that will be visible. Typical applications include furniture and cabinets.

Traditional wood-based fiberboard including medium-density fiberboard and hardboard, are stronger and denser than traditional wood-based particleboard and denser than plywood. Traditional wood-based fiberboard may be formed by breaking down hardwood or softwood residuals into wood fibers, and then combining the fibers with wax and a resin binder, and forming panels by applying high temperature and pressure. Applications include furniture, display cabinets, wall-panels and storage units.

U.S. Pat. No. 4,968,549, the entire contents of which are hereby incorporated by reference herein, discloses a laminated material in board form made by the steps of cutting open a lignocellulosic stalk, such as sorghum, sugar cane, or corn in the fiber direction with a knife; flattening the lignocellulosic stalk by means of a roller press to form a compressed stalk, one face of which consists of its epidermis; arranging a plurality of the compressed stalks in parallel with each other to form a sheet; coating the sheet with a resin adhesive; stacking a plurality of the sheets coated with the adhesive; and then bonding with heat and pressure by means of a hot press. U.S. Pat. No. 4,968,549 further indicates that the laminated material has an equal to or higher flexural strength than conventional plywood or also has excellent sound absorbing and heat insulating properties in comparison with conventional particleboard or fiberboard.

Binders used to produce traditional wood-based composite materials including particle board, fiberboard and OSB panels include thermosetting plastic resins such as urea formaldehyde (UF), phenolic resins such as phenol formaldehyde (PF) and formaldehyde-free, isocyanate resins such as polymeric methylene diphenyl diisocyanate (PMDI).

Products such as traditional wood-based OSB, particle board and fiber board that are made with resins such as UF and PF release formaldehyde and other volatile organic compounds (VOC's) over the life of the product and may be hazardous as formaldehyde is a known carcinogen and formaldehyde emissions have been linked to respiratory illness, asthma and premature death, especially for children and the elderly.

As used herein, formaldehyde-free binder means that the binder does not contain non-trace amounts of formaldehyde or materials that release formaldehyde during the life of the product.

As used herein, the term “Volatile Organic Compound” (VOC) means materials having organic chemicals that have a high vapor pressure at ordinary, room-temperature conditions. Their high vapor pressure results from a low boiling point, which causes large numbers of molecules to evaporate from the liquid or solid form of the compound and enter the surrounding air. An example is formaldehyde, with a boiling point of −19° C. (−2° F.), slowly exiting paint and getting into the air. The term “zero VOC” means a material having zero detectable VOC's using standard detection equipment.

Various properties of Wood-Base Fiber, agrifiber and Particle Panel may be tested in accordance with ASTM D 1037-99. These properties can include Moisture Absorption, Thickness Swelling, Volume Swelling arid Linear Expansion.

The modulus of rupture (MOR) and modulus of elasticity (MOE) can be determined by a static, three point bending test in accordance with ASTM D 1037-99. The internal bond strength (IB) can be determined by testing tensile strength perpendicular to the board surface in accordance with ASTM D 1037-99.

Other Test standards suitable for Evaluating Properties of Wood-Base Fiber, Agrifiber and Particle Panel include;

| Test Standard | Physical Property to be Established |
|---|---|
| USFPL 1344 | Mold Resistance |
| ASTM E-661 Method A | Concentrated Impact Load resistance |
| ASTM D-1761/1037 | Fastener Holding Performance |
| ASTM D-3043 Method C | Panel Bending Strength and Stiffness |
| ASTM D-3501 Method B | Panel Compression Properties |
| ASTM D-1037: | Linear Expansion - Humidity Change (108-111) |
| ASTM D-1037: | Strength Properties: Static Bending (11-20) |
| ASTM D-1037: | Tensile Strength Parallel to Surface (21-27) |
| ASTM D-1037: | Tensile Strength Perpendicular to Surface (28-33) |
| ASTM D-1037: | Direct Screw Withdrawal Test (61-67) |
| ASTM D-1037: | Abrasion Resistance by the U.S. Navy Wear |
| | Tester (96-99) |
| ASTM D-1037 | Linear Variation with Change in Moisture |
| | Content (108-111) |
| ASTM D-1037: | Interlaminar Shear (122-129) |

Test methods for Evaluating Formaldehyde Emission and Content Properties of Wood-Base Fiber, agrifiber and Particle Panel include;

Large Chamber (ASTM E1333)

Desiccator (ASTM D5582)

Small Chamber (ASTM D6007)

Japanese 2.4 Hour Desiccator (JIS A1460)

Perforator (EN 120), Single Extraction

Perforator (EN 120), Duplicate Extraction

Unless otherwise specified, all test results reported herein were conducted using the test methods provided above.

In light of the above, it is an object of the present invention to provide press-board products made from materials having a relatively low adverse environmental impact. Still another object of the present invention is to provide formaldehyde-free press-board products that contain zero VOC's. Yet another object of the present invention is to provide composite boards made with sorghum stalks and a thermoplastic binder and processes for making same which are easy to use, relatively simple to implement, and comparatively cost effective.

### SUMMARY OF THE INVENTION

For the present invention, a composite board includes a sorghum stalk material component and a thermoplastic binder component. To prepare the composite board, the sorghum stalk material is first harvested. The sorghum stalk material can include sorghum stalk bagasse (the stalk material remaining after juice extraction for ethanol production) and/or Sorghum stalks. In one particular implementation, stalk material from energy sorghums such as sweet sorghum and forage sorghum hybrids are used. In one implementation, the sorghum stalk material is harvested using a mower/conditioner. In this process, sorghum stalks and first cut (i.e. mowed) at or near their base and conditioned by crimping the stalks every 12 to 18 inches along their length to crack open the epidermis to allow the stalk to air dry at the harvest site.

In some cases, mechanical or chemical processing may be used to remove or peel the waxy outer coating from the stalk material (for example, see U.S. Pat. No, 4,968,549, the entire contents of which are hereby incorporated by reference herein). The stalks may be dried naturally or dried using an industrial dryer to a moisture content of less than about 10% by weight, and more typically, to a moisture content in the range of 1 to 5%.

The stalk material may be mechanical processed (either before or after drying) to produce stalk material suitable for the final product (see below) including stalk segments for preparing oriented sorghum strand board (OSSB), slit open stalks for preparing slit sorghum stalk board, stalk fiber for fiberboard and stalk particles for particleboard.

When fibers are used (i.e. for OSSB and fiberboard), the stalk segments can be refined can reduce the fiber size and split grain sorghum. For this purpose, a mill such as a disc mill may be used. For example, a disc mill have a mill gap set at 0.3 inch can be used. After cutting and/or milling, the stalks and/or stalk segments may be filtered, screened or cleaned at various times during the process to remove fines, etc. For example, in one implementation, the sorghum is refined and then screened to remove small particles (i.e. fines), leaves, and epidermis. For example, an oscillating screener having two screens, a top screen with 20 mm openings and a bottom screen size with 5 mm openings can be used. In some implementations, the stalks may be softened, for example by water soaking or steaming.

The stalk segments may be mixed with small amounts, e.g. less than 5% by weight, of other fibrous or non-fibrous materials such as wood, other sorghum plant portions, corn plant portions, sugar plant portions, etc. Stalk material may be filtered, screened or cleaned at various times during the process to remove dirt, impurities, sorghum fines, etc. In some implementations, the stalks may be softened, for example, by water soaking or steaming.

The dried sorghum stalk material is combined with a binder including a thermoplastic resin. Thermoplastic resins can include, but are not necessarily limited to acrylonitrile-butadiene-styrene (ABS) resins, acetals, nylons (polyamides), high density polyethylenes (HDPE) including co-polymers, low density polyethylenes (LDPE), including co-polymers, polypropylenes (including co-polymers), polystyrenes, and vinyls.

The thermoplastic resin can be used alone in the binder, or, in some aspects, a thermoset resin may be used with a thermoplastic resin (see description below). Thermoset resins can include, but are not necessarily limited to alkyds, allylics, the amines (melamine and urea), epoxies, phenolics, polyesters, silicones, urethanes, isocyanate resin such as polymeric methylene diphenyl diisocyanate (PMDI) and protein based resins. For example, the protein based resin can consist of a soy protein based resin, a canola protein based resin, a castor protein based resin, jatropha protein based resin or a combination of different protein based resins.

In some cases, the stalk material may be mixed with the thermoplastic material using melt blending or air laying, both of which are described in U.S. Pat. No. 6,787,590 granted Sep. 7 2004 to Nakayama at al and titled “Composites comprising plant material from Parthenium spp, and plastic”, the entire contents of which are hereby incorporated by reference herein.

Recycled, virgin or recycle/virgin blends of thermoplastic material may be used. For example, in one implementation, used, empty HDPE milk containers, e.g. gallon, half gallon or quart size, may recycled and used. For example, the recycled milk containers and/or other recycled products may be cleaned, shredded and mixed with virgin HDPE pellets and colorants (pigments) or other processing additives such as UV inhibitors. The recycled HDPE may be formed into thin films, e.g. having a thickness of 0.5-3 mm. As described below, these thin films can be combined with sorghum stalk material in layers and placed into a press. Specifically, the HDPE can include purified blends of post consumer, post industrial and/or virgin HDPE base resins. Additional additives may be compounded into the base resin to improve strength and stiffness.

The thermoplastic material may be used alone or together with a thermosetting binder such as a formaldehyde-tree, isocyanate resin such as polymeric methylene diphenyl diisocyanate (PMDI) or a soy protein based resin.

For example, the thermosetting binder component may be sprayed using nozzles onto the sorghum stalk material or may be applied in a tumbler. Other techniques include curtain coating, roller coating and dipping. The thermoplastic material may then be mixed with the thermoset coated stalks using melt blending or air laying or may be added directly onto the press platen as described below and/or between layers of sorghum stalk material.

Typically, a suitable ratio of binder to stalk material is 6-15% by weight of binder and 85-94% by weight stalk material. When a mixture of PMDI (or soy protein resin) and HDPE is used as the binder, a typical ratio includes about 8-12% by weight of HDPE, 2-4% by weight PMDI and about 80-90% by weight stalk material. In one implementation, a target of about 10% by weight of HDPE, 4% by weight PMDI and about 86% by weight stalk material may be used.

In one aspect, the polymeric methylene diphenyl diisocyanate (PMDI) may be a formaldehyde-free, isocyanate resin. For example, a PMDI resin such Rubinate 1840 sold by Huntsman.

Once coated with thermosetting resin, the hinder coated sorghum stalk material can be placed into one or more layers, depending on whether OSSB, fiberboard, particle board or a slit sorghum stalk board is being prepared. The layer(s) are then place in a press with the HDPE material, e.g. film, and thermocompressed between heated flat platens. In some cases, the layers of sorghum stalk material may be pre-pressed at an elevated temperature, e.g. at about 350 degrees F., prior to combination with the HDPE. The pre-pressed layers are then combined with the HDPE, e.g. film, and pressed at a temperature sufficient to melt the HDPE. One or more thermocompressions may be employed. Various press temperatures, pressures and durations may be employed depending on the board type, the desired board thickness and desired board density. Typically, thickness and density are specified, and the layer/stack input thickness and press pressure are varied, to obtain the desired final thickness and density. Typically, a precompressed layer thickness of about 4-5 inches will compress to about ½ inch.

After pressing, the board is cooled. For example, cooling water may be piped through the press platens to cool the board below the thermoplastic resin softening point, and in some cases to room temperature before further processing (i.e. handling or trimming). Alternatively, the material may be thermocompressed between caul sheets, and, after thermocompressing, the board and caul sheets may be removed from the press and allowed to air cool or put in a cooling press. After cooling, the board may be trimmed.

### BRIEF DESCRIPTION OF THE DRAWINGS

The novel features of this invention, as well as the invention itself, both as to its structure and its operation, will he best understood from the accompanying drawings, taken in conjunction with the accompanying description, in which similar reference characters refer to similar parts, and in which:

FIG. 1 is a is a process flow chart showing steps for preparing an oriented strand board containing sorghum stalk material and a thermoplastic binder;

FIG. 2 is a perspective view showing a fin/frame assembly for orienting and layering binder coated sorghum stalk material;

FIG. 3 is an isometric view of a stack of binder coated sorghum stalk material having three layers, with each layer oriented orthogonal to adjacent layers;

FIG. 4 is a front plan view of a stack of binder coated sorghum stalk material having three layers positioned between release coated press platens;

FIG. 5 shows an oriented strand board containing sorghum stalk material and a thermoplastic binder board after pressing;

FIG. 6 shows an oriented strand board containing sorghum stalk material and a thermoplastic binder after trimming; and

FIGS. 7˜10 show measured properties for an oriented strand board containing sorghum stalk material and a thermoplastic binder.

### DESCRIPTION OF THE PREFERRED EMBODIMENTS

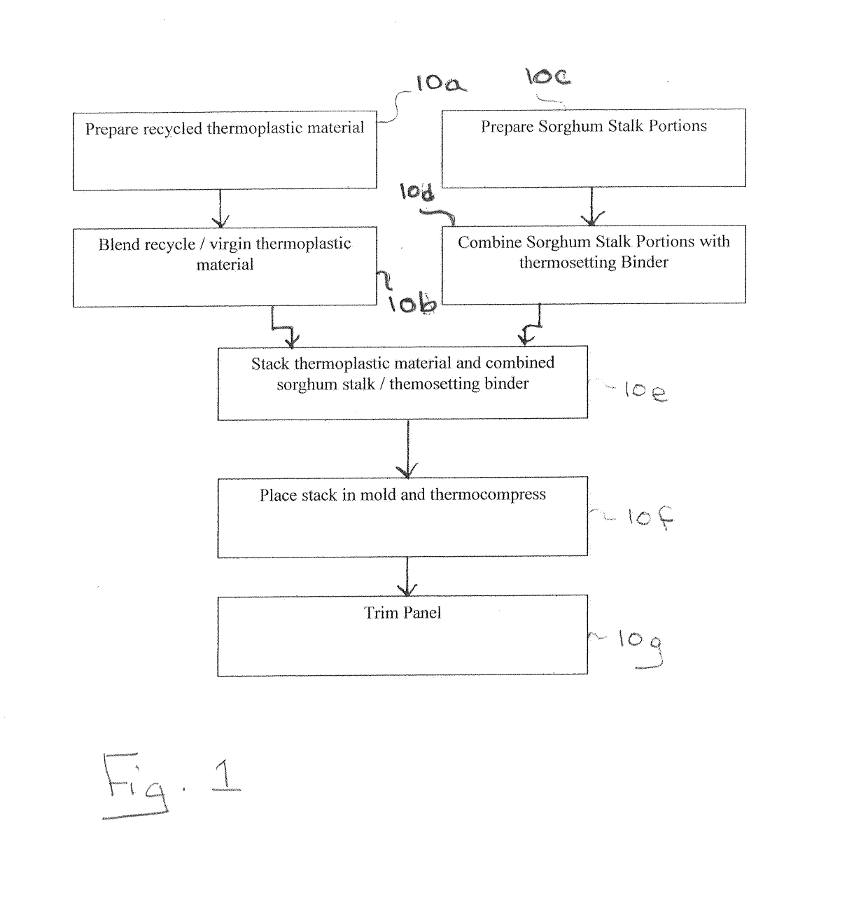

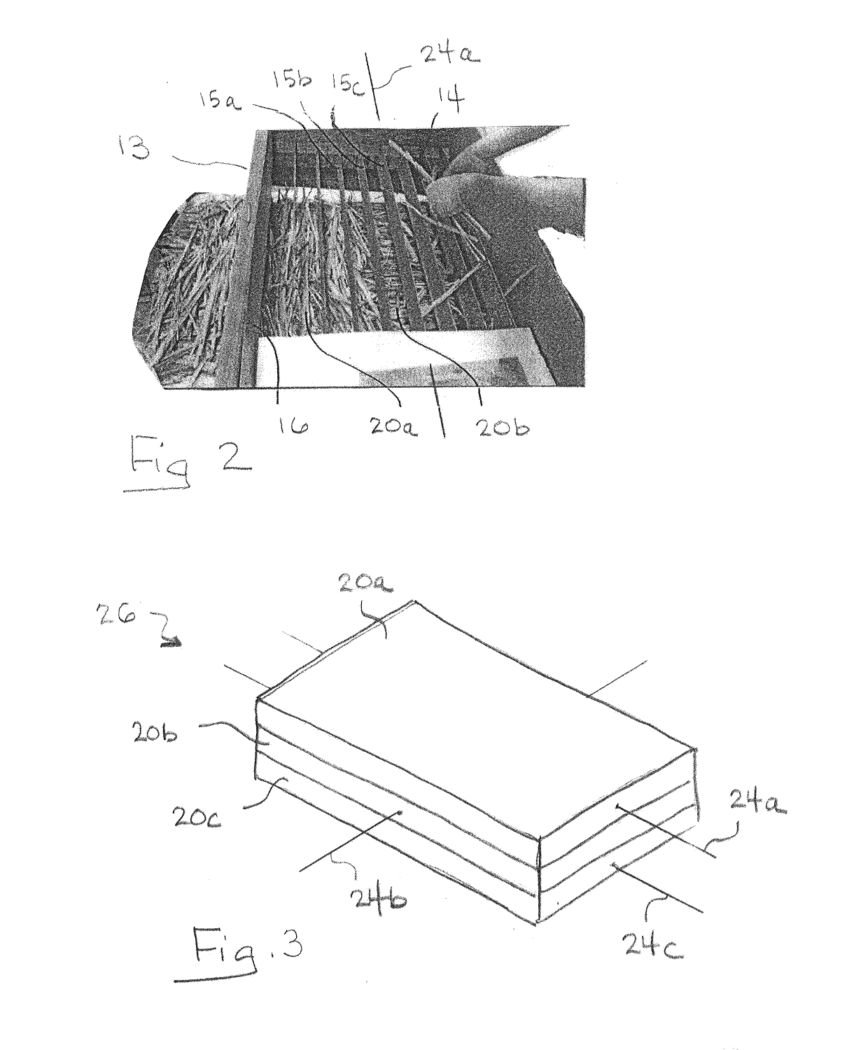

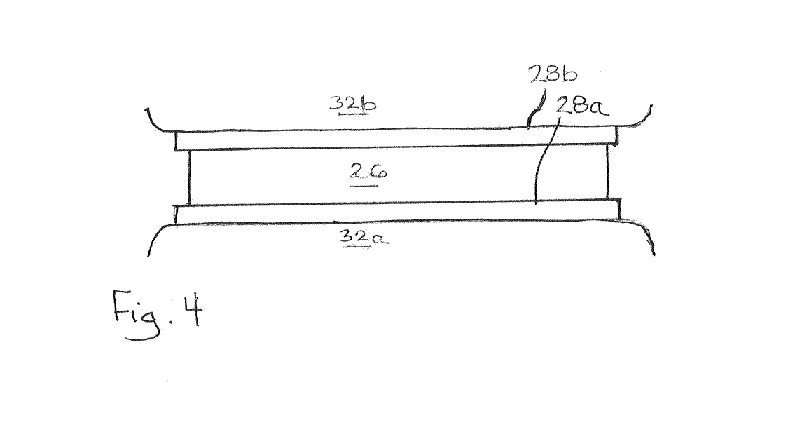

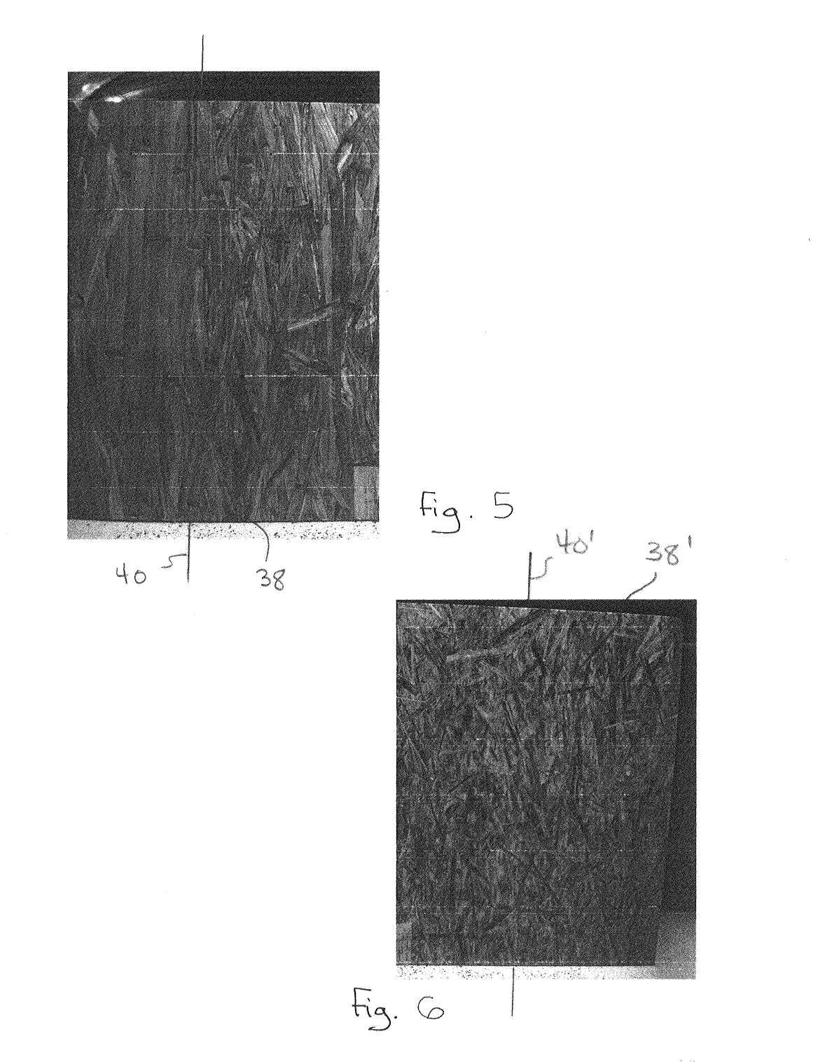

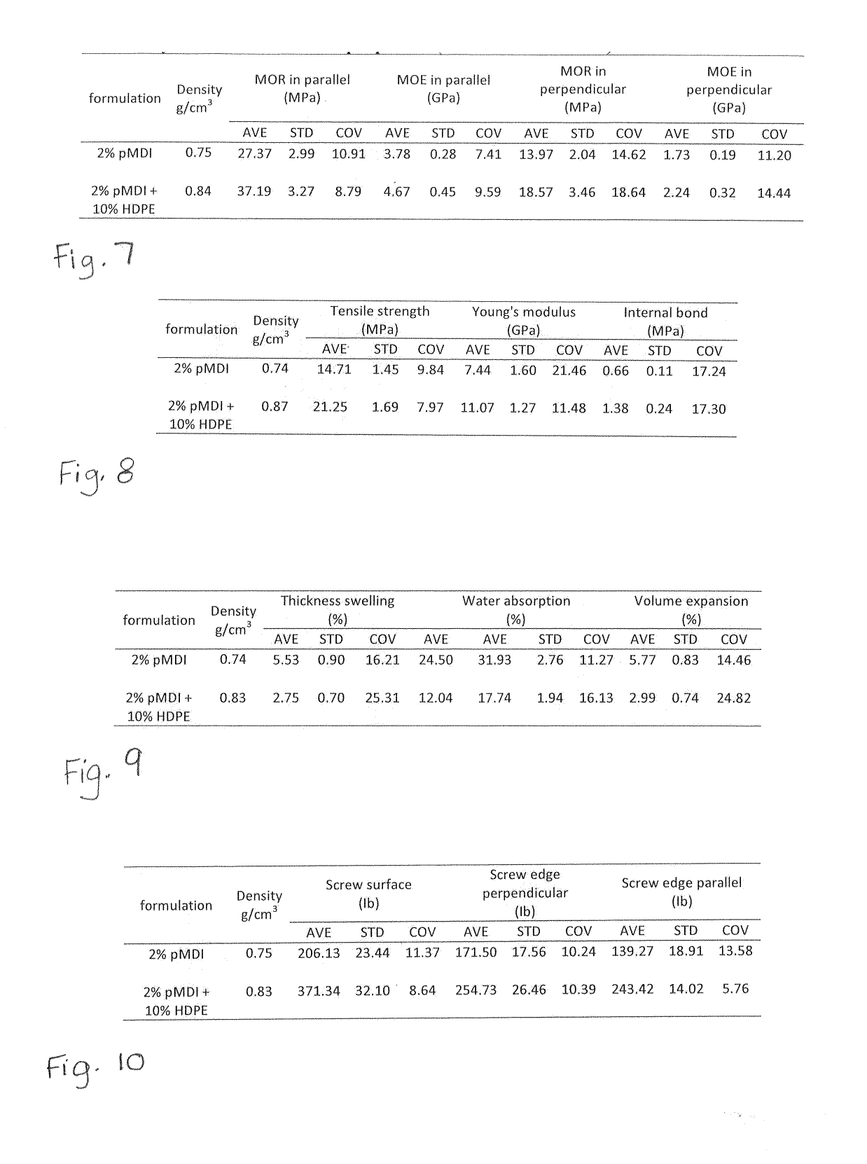

FIG. 1 shows a process for preparing a composite board containing sorghum stalk material and a recycled thermoplastic binder such as an oriented strand board, fiberboard, particleboard or slit sorghum stalk board. Uses of the composite board containing sorghum stalk material and a thermoplastic binder can include, but are not necessarily limited to interior panels, furniture, flooring, wall sheathing, countertops, tabletops, bars, and interior design.

As shown in FIG. 1, the process begins by preparing recycled thermoplastic material (box 10a). This step can include, for example, cleaning and shredding empty HDPE milk containers. Box 10b shows that the recycled thermoplastic material may be combined with virgin thermoplastic material to produce a material having improved properties. As described above, the resultant blend can be provided in the form of a thin film.

Continuing with FIG. 1, the process further includes the steps of preparing sorghum stalk portions (box 10c). More specifically, the sorghum stalk portions can be prepared as described above by stalk harvesting, conditioning, drying, refining and screening. Once prepared, the sorghum stalk portions may be combined with thermosetting binder (box 10d), as described above. Also indicated above, the binder may include a thermosetting resin such as PMDI and/or a protein based resin such as a soy protein based resin. When used, a soy protein based resin may be produced from soy meal/flour, soy protein concentrate or soy protein isolate. The soy protein based resin may be self-crosslinking or used with a cross linker. The soy protein based resin may be in alkaline form or as a slightly acidic dispersion. For example, the preparation of a soy protein resin having a slightly acidic dispersion can include denaturation of soy flour to expose groups for reaction and adhesion, introduction of viscosity/performance stability; modification and stabilization, for example with CH₂O₂, copolymerization, for example with PMDI; and inversion with acid addition. The soy protein based resin may be denatured and copolymerized with small amounts of reactant to produce a product that is biologically stable.

For example, soy protein based resin Soyad adhesive product #D-40999 and the cross-linker product #D-40767 containing 1,3-dichloropropan-2-ol (1,3-DCP), available from Heartland Resource Technologies, LLC—Ashland may be used. The properties of each are listed in the table below.

| | | D-40767 |
|---|---|---|
| | D-40999 | Cross- |
| | Soyad | Linker |
| Solids | 50.0 | 45.0 |
| % | | |
| Viscosity | 1500 | 250 |
| (cP) | | |
| pH | 4.2 | 5.5 |

The method for using these products together is as follows: Mix the two components no more than 4 hours prior to its intended use; Charge the Soyad (D-40999) to a mixing vessel; add the cross-linker (D-40767) such that the ratio is 20 parts cross-linker to 100 parts of Soyad on a solids basis; stir material 5-10 minutes such that resultant mixture is homogeneous. The solids, viscosity and pH of the resultant blend will be 49.1%, ˜1000 cP and ˜4.5 respectively.

Continuing with FIG. 1, it can be seen that once the sorghum stalk portions have been combined with thermosetting binder, the coated sorghum stalk material is placed into one or more layers (boxes 10e). These layers may be pre-pressed as described above. Next, the coated sorghum stalk material layers are combined with one or more layers of thermoplastic film to create a stack. FIG. 1 shows that the stack is then placed in a press and thermocompressed (box 10f). After the board has cooled sufficiently, FIG. 1 shows that the board may be trimmed to size (box 10g).

FIG. 2 shows a fin/frame assembly 13 that can be used for orienting and layering binder coated sorghum stalk material 14 to produce oriented sorghum strand board (OSSB) that contains thermoplastic binder. It can be seen that the fin/frame assembly 13 includes a plurality of spaced apart parallel fins 15a-c that are secured to a wooden frame 16 to establish the fin/frame frame assembly 13. As shown, the binder coated sorghum stalk material 14 is passed through the fins 15a-c to produce layer 20a on top of previously deposited layer 20b. As shown, the fins 15a-c are aligned parallel to a desired layer axis 24a for the layer 20a. Once a layer 20a,b is complete, the fin/frame assembly 13 can be lifted and reoriented, e.g. rotated, to prepare for loading stalk material 14 in a subsequent layer. For the fin/frame assembly 13, the height of the fins 15a-c can be used to gauge and regulate the layer height. The number and spacing of the fins 15a-c can be varied to increase or decrease the variation in alignment of the stalk material 14 in the layer 20a,b. The frame 16 can be sized to produce the desired OSSB sheet size, for example, to produce a 4′×8′ sheet, a suitable frame 16 of about 5′×9′ may be employed. Typically, a fin spacing in the range of about 2-3 inches may be used. A typical pre-compressing layer depth in the range of about 4 to 5 inches may be used.

FIG. 3 shows a stack 26 having three layers 20a-c, with each layer 20a-c oriented orthogonal to adjacent layers 20a-c. Specifically, as shown, top layer 20a has a layer axis 24a, layer 20b has a layer axis 24b and bottom layer 20c has a layer axis 24c. For FIG. 2, it can be seen that layer axis 24a is substantially parallel to layer axis 24c and layer axis 24b is substantially orthogonal to both layer axis 24a and layer axis 24c. Although three layers 20a-c are shown, it is to be appreciated that more than three and as few as one layer 20a-c may be used. Typically, to produce a board having superior strength along one of the board axes, an odd number of layers 20a-c are used and the exterior layers (e.g. layers 20a and 20c) are aligned in parallel. Typically, as shown in FIG. 2, in each layer 20a, the stalk material 14 is oriented along a layer axis 24a such that at least 90% of said sorghum stalk material 14 is aligned within +/−45 degrees of the layer axis 24a. In some implementations, the stalk material 14 may be combined with binder after orienting and/or layering. As an alternative to the fin/frame assembly 13 shown in FIG. 2, mechanized equipment (not shown) similar to equipment used in traditional wood OSB manufacturing can be used to orient and layer the coated sorghum stalk material 14.

FIG. 4 shows a stack 26 together with two layers of thermoplastic film 28a,b positioned between release coated press platens 32a,b. As shown, film 28a may be placed on the bottom release coated platen 32a and film 28b may be placed adjacent the top release coated platen 32b. Alternatively, or in addition to films 28a,b, the HDPE can be combined with the stalk material as described above (i.e. using melt blending or air laying) or films 28a,b can be placed between layers 20a-c (see FIG. 3).

The stack 26 may be layered directly on a press platen 32a or the stack 26 may be layered, for example on a caul sheet (not shown), and then placed onto the platen 32a. Once positioned, the stack 26 and thermoplastic film 28a,b may be thermocompressed in a press (not shown) between heated flat platens 32a, b.

One or more thermocompressions may be employed. Press temperature, pressure and duration may depend on board thickness and desired board density. Typically, thickness and density are specified, and the layer/stack input thickness and press pressure are varied, to obtain the desired final board thickness and density. Typically, a precompressed stack thickness of about 4-5 inches will compress to about ½ inch. Typical range of press temperatures include 125 deg F. to about 400 deg F., typical pressures include 100-300psi and typical compressions include 2-5 minutes closing time and 3-10 minutes duration. In one implementation, a press temperature of about 150 deg F., press temperature of about 200 psi and a duration of about 6 minutes may be used.

FIG. 5 shows a board 38 after pressing having an exterior layer axis 40 (i.e. the top and bottom layer having stalk material aligned along axis 40) manufactured with stalk portions having a length of about 6 inches to 20 inches.

FIG. 6 shows a board 38′ after pressing having an exterior layer axis 40′ (i.e. the top and bottom layer having stalk material aligned along axis 40′) manufactured with stalk portions having a length of about 4 inches to 6 inches.

After pressing, the board may be trimmed to size. Final board densities range from 42 to 54 lbs/ft³.

To prepare sorghum fiberboard or particleboard, the stalks are first mechanically processed (either before or after drying) to produce, as applicable, stalk fiber, stalk particles, or a combination thereof, for example, by chopping and/or waferizing the stalk material. Typically, the step involves processing the stalk material into fibers having a length in the range of about 4 to 6 inches, or particles having a size of about 3.5 mm.

Next, the stalk fiber/particles may be combined with a thermosetting resin using one of the techniques described above.

The combined stalk material/thermoset binder may be thermocompressed in a press between heated flat platens. As shown in FIG. 2, one or more layers of HDPE may be placed directly in the press. For example, a layer may be placed on the bottom platen and a second layer may be placed adjacent the top platen. Alternatively, or in addition to the HDPE layers, the HDPE can be combined with the stalk material as described above (i.e. using melt blending or air laying).

One or more thermocompressions may be employed. Press temperature, pressure and duration may depend on board thickness and desired board density. Typically, thickness and density are specified and layer/stack input thickness, and press pressure are varied to obtain desired final thickness and density. Typically, a precompressed layer thickness of about 4-5 inches will compress to about ½ inch. Typical range of press temperatures include 125 deg F. to about 400 deg F., typical pressures include 100-300psi and typical compressions include 2.5 minutes closing time and 3-10 minutes duration. In one implementation, a press temperature of about 150 deg F., press temperature of about 200 psi and a duration of about 5 minutes may be used.

After pressing, the board may be trimmed to size.

Final board densities range from 42 to 54 lbs/ft³.

To prepare Slit Sorghum Stalk Board, the stalks are first mechanical processed (either before or after drying) to produce slit stalk material, for example by cutting or slicing half way through the stalk and flattening the slit stalk or cutting or slicing through the stalk producing stalk halves.

Next, the slit stalk material may be combined with a thermosetting resin using one of the techniques described above.

Next, the thermoset resin coated sorghum stalk material is oriented and layered. Specifically, the slit stalks may be oriented parallel and adjacent each other in a single layer. Additional layers may be oriented orthogonally to each underlying layer, and in some cases, a thin layer of wood, such as 1/32″ poplar may be inserted between layers. Layers may be thermocompressed before stacking or a stack of layers may be thermocompressed. Layers may be stacked directly on a release coated press platen or the layers may be stacked and then placed onto the platen.

A single layer or multiple layers may be used. In one aspect, at least three layers are used. In one aspect, exterior layers are aligned in parallel. In one aspect, each layer is oriented substantially orthogonal to adjacent layers in the stack. In some implementations, the stalk material may be combined with binder after orienting and/or layering.

One or more layers of HDPE may be placed adjacent to each layer prior to pressing. When slit stalk layers are pressed individually, the HDPE layer can be placed directly in the press. For example, a layer may be placed on the bottom platen and a second layer may be placed adjacent the top platen. Alternatively, or in addition to the HDPE layers, the HDPE can be combined with the stalk material as described above. When a stack of slit stalk layers are pressed, each layer of slit stalk may include HDPE, for example, as one or more layers.

One or more thermocompressions may be employed. Press temperature, pressure and duration may depend on board thickness and desired board density. Typically, thickness and density are specified and layer/stack input thickness, and press pressures are varied to obtain desired final thickness and density. Typically, a precompressed layer thickness of about 4-5 inches will compress to about ½ inch. Typical range of press temperatures include 125 deg F. to about 400 deg F., typical pressures include 100-300psi and typical compressions include 2-5 minutes closing time and 3-10 minutes duration. In one implementation, a press temperature of about 150 deg F., press temperature of about 200 psi and a duration of about 5 minutes may be used.

After pressing, the board may be trimmed to size.

Final board densities range from 42 to 48 lbs/ft³.

### EXAMPLE

An oriented sorghum strand board containing sweet sorghum and thermoplastic binder was prepared and tested. The following table shows the length distribution of sweet sorghum with 1˜2 mm in thickness. Pre-crushed sweet sorghum was oven-dried at 103° C. to a moisture content of below 3%. The fiber was screened.

| Fiber type | Length | | Width | Thickness | Content |
|---|---|---|---|---|---|
| Long fiber | Above 45 | mm | | | 25% |
| Median fiber | 19-45 | mm | 5-10 mm | 1-2 mm | 48% |
| Small fiber | 13-19 | mm | | | 27% |

High-density polyethylene films were purchased from Tee Group Films. The thickness of the film was 0.1 mm, with a melting point of 135° C. and a melt flow index of 20. Polymeric diphenylmethane diisocyanate (pMDI, MONDUR® 541) was obtained from Bayer Material Science, Pittsburgh, Pa. Two percent of pMDI based on sweet sorghum dry weight was used. The sweet sorghum was first oven-dried, and then 2% pMDI was sprayed onto the fiber in a roller mixer. The fiber with pMDI was evenly separated into five parts for forming. The HDPE films were divided into six parts and were placed between the sweet sorghum layers and both surfaces of the mat. Ten percent of HDPE film was put on the top or bottom of mat and 20% of HDPE film was put between the five fiber layers, so each surface of fiber layer have 10% of HDPE film. Sweet sorghum was oriented formed in a forming box with a vane distance of 76 mm. Silicon release papers were put on the surfaces of the mat to prevent sticking with metal caul plates. The mat was sent to hot press for 10 minutes at a temperature of 160° C. The hot pressing was thickness controlled. First, the mat thickness was decreased from 127 mm to 20 mm in 40 seconds, and then was decreased to target thickness 15 mm in 300 seconds, followed by 10 minutes hot pressing when keeping at target thickness. Finally, cooling water was piped into the hot-press platens, and the mat was gradually cooled to around 35° C. before removal (30 minutes cooling).

FIGS. 7˜10 show properties of board having approximately 98 percent sweet sorghum and 2 percent PMDI (by weight) pressed to a final density of about 0.75 g/cm³, and a board having approximately 86 percent sweet sorghum, 10 percent HDPE and 2 percent PMDI (by weight) pressed to a final density of about 0.83 g/cm³.

While the particular embodiment(s) are described and illustrated in this patent application in the detail required to satisfy 35 U.S.C. 112, it is to be understood by those skilled in the art that the above-described embodiment(s) are merely examples of the subject matter which is broadly contemplated by the present application. Reference to an element in the following Claims in the singular, is not intended to mean, nor shall it mean in interpreting such Claim element “one and only one” unless explicitly so stated, but rather “one or more”. All structural and functional equivalents to any of the elements of the above-described embodiment(s) that are known, or later come to be known to those of ordinary skill in the art, are expressly incorporated herein by reference and are intended to be encompassed by the present Claims. It is not intended or necessary for a device or method discussed in the Specification as an embodiment, to address or solve each and every problem discussed in this Application, for it to be encompassed by the present Claims. No element, component, or method step in the present disclosure is intended to be dedicated to the public regardless of whether the element, component, or method step is explicitly recited in the Claims. No claim element in the appended Claims is to be construed under the provisions of 35 U.S.C. 112, sixth paragraph, unless the element is expressly recited using the phrase “means for” or, in the case of a method claim, the element is recited as a “step” instead of an “act”.

What is claimed is:

1. A board comprising a binder material and sorghum stalk portions, wherein said board includes at least 70 percent sorghum stalk portions by weight and at least 8 percent thermoplastic binder by weight.

2. The board as recited in claim 1 wherein said thermoplastic binder material comprises high density polyethylene.

3. The board as recited in claim 1 wherein said thermoplastic binder material comprises recycled high density polyethylene.

4. The board as recited in claim 1 wherein said binder material is a formaldehyde-free binder.

5. The board as recited in claim 1 wherein said binder material contains zero volatile organic compounds (VOC).

6. The board as recited in claim 1 wherein said binder material comprises polymeric methylene diphenyl diisocyanate (PMDI).

7. The board as recited in claim 1 wherein said binder material comprises a protein based resin.

8. The board as recited in claim 5 wherein said protein based resin is selected from the group of protein based resins consisting of a soy protein based resin, a canola protein based resin, a castor protein based resin, jatropha protein based resin and combinations thereof.

9. The board as recited in claim 1 wherein said board includes 80 to 90 percent sorghum stalk portions by weight, 8 to 12 percent recycled high density polyethylene and 3 to 5 percent polymeric methylene diphenyl diisocyanate (PMDI) by weight.

10. The board as recited in claim 1 wherein the board comprises at least two oriented strand layers, each oriented strand layer containing a binder material and sorghum stalk portions, each oriented strand layer having a layer axis with greater than 90% of said sorghum stalk portions aligned within +/−45 degrees of said layer axis, and wherein at least one oriented strand layer has a layer axis oriented at a non-zero angle relative to a layer axis of another oriented strand layer.

11. The board as recited in claim 1 wherein said board is selected from the group of board types consisting of oriented strand board, fiber board, particle board and slit sorghum stalk board.

12. The board as recited in claim 1 wherein the sorghum stalk portions comprise sorghum bagasse.

13. The board as recited in claim 1 wherein the sorghum stalk portions comprise energy sorghums.

14. The board as recited in claim 1 wherein said board has a density in the range of 42 to 54 lbs/ft³.

15. A method of manufacturing a board, the method comprising the steps of:
combining a binder material and sorghum stalk portions to produce a combined material, wherein said combined material includes at least 70 percent sorghum stalk portions by weight and at least 8 percent thermoplastic binder by weight;
heating and pressing said combined material.

16. The method of step 15 wherein the heating and pressing step is accomplished in a press at a temperature in the range of 125 to 400 degrees Fahrenheit.

17. The method of step 15 wherein the heating and pressing step is accomplished in a press at a pressure in the range of 100 to 300 psi.

18. The method of step 15 wherein said sorghum stalk portions have a moisture content in the range of about 1.0 to 5.0 percent when combined with the binder.

19. The method of step 15 further comprising the steps of:
harvesting sorghum by mowing sorghum stalks:
conditioning each mowed stalk at the harvest site by crimping the mowed stalk at a plurality of locations to increase sorghum stalk drying;
refining sorghum stalk material into fibers using a mill;
screening the fibers to remove sorghum fines.

20. A board made by a process comprising the steps of:
combining a binder material and sorghum stalk portions to produce a combined material, wherein said combined material includes at least 70 percent sorghum stalk portions by weight and at least 8 percent thermoplastic binder by weight;
heating and pressing said combined material.
